(19) United States
(12) Patent Application Publication
(10) Pub. No.: US 2010/0309380 A1
(43) Pub. Date: Dec. 9, 2010

(54) Method and apparatus for providing and reducing dynamic chroma copy protection effects by modifying luminance copy protection signals

(75) Inventor: Ronald Quan, Cupertino, CA (US)

Correspondence Address: PATENT DEPARTMENT;ROVI CORPORATION, 2830 DE LA CRUZ BOULEVARD, SANTA CLARA, CA, 95050, US

(73) Assignee: Macrovision Corporation

(21) Appl. No.: 12/455,764

(22) Filed: Jun. 5, 2009

(51) Int. Cl. H04N 9/77

(52) U.S. Cl. 348/663; 348/E09.035

(57) ABSTRACT

Chroma copy protection signals are provided or synthesized for component or composite video signals by modifying one or more luminance copy protection signal. The system takes advantage of the characteristics of component video signals, wherein the luminance signal (channel) generally is subject to automatic gain control while the chrominance signal (channel) is decoupled from the luminance signal in automatic gain control (AGC) systems of a video recorder. Accordingly, when a copy protection signal is applied to the luminance signal but does not affect the chrominance signal, a video recorder will output a signal with an attenuated luminance signal and a full amplitude chrominance signal. This causes erroneous color saturation effects. An alternative embodiment provides method and apparatus for reducing or defeating chroma copy protection effects such as disclosed herein.

### BACKGROUND OF THE INVENTION

The invention pertains to video copy protection signals and more particularly to providing or synthesizing chroma copy protection effects for component or composite video signals by providing one or more luminance copy protection signal. An alternative embodiment of the invention includes the circumvention of the chroma copy protection effects in a video copy protection signal.

The video copy protection signal is provided in media players or receivers via one or more control bits and is generally playable on a television (TV) set, while causing undesirable effects on an illegal copy. Prior art copy protection signals in a composite video signal cause both luminance (luma) and chrominance (chroma) signals to be affected. For example, both luma and chroma signals of the composite video signal are attenuated in an automatic gain control (AGC) system of a recorder, which provides accordingly a copy protection effect of loss in amplitude of both the luma and chroma subcarrier signals.

However, in a component video signal, the luma signal is affected by the AGC system of a video recorder while the chroma signal is not, which causes erroneous color saturation, for example, chroma oversaturation, chroma de-saturation, etc.

Alternatively, in prior art circumvention devices (e.g., “black boxes”), it is the AGC pulses and or pseudo sync pulses of a copy protection signal which are modified to allow for a recordable copy of the video signal.

### SUMMARY AND OBJECTS OF THE INVENTION

The present invention takes advantage of the characteristics of component video signals such as, for example, S-Video signals, and corresponding systems, wherein the luma channel generally is subject to automatic gain control while the chroma channel is decoupled from the luminance channel in automatic gain control (AGC) systems of a video recorder. That is, applying a copy protection signal to the luminance signal causes attenuation of the luminance signal in the recorder, but the chrominance signal is not attenuated in the recorder.

For example, in an embodiment of the invention, when a copy protection signal is provided in the luma channel (Y) in an S-Video system, such as in SVHS recorders, while leaving the chroma channel (C) without a copy protection signal, the SVHS recorder will output a signal with attenuated Y signal but full amplitude C signal.

In another embodiment, with a modulated copy protection signal in the Y channel, the output of the SVHS recorder system exhibits a time varying luma signal (e.g., the active video and sync signals vary in amplitude over time), but a constant amplitude chroma signal (e.g., the color burst is constant amplitude over time).

Because the chrominance signal is not varying in relation to the effects of the luminance signal with modulated luminance copy protection signals, the net effect of the signals when displayed in a TV set is varying abnormal amounts of color saturation. This net effect is due to the chrominance signal having the increased level relative to the varying attenuated luminance signal. For proper color saturation of a picture, the Y and C channels must have correct levels, such as sync and color burst amplitudes must be substantially the same. If the sync amplitude is lower (such as when an AGC system lowers the amplitude of luminance and sync) while the color burst amplitude remains the same amplitude, there is an oversaturation color effect. If the sync amplitude and luma amplitude continue to decrease, then the color oversaturation effect increases further.

Thus, one embodiment of the present invention provides a component (e.g., Y/C) copy protection signal that provides oversaturation, or dynamic oversaturation, of color(s) by applying luminance copy protection signals such as AGC pulses, and or pseudo sync pulses and AGC pulses, in at least one horizontal blanking interval. Optionally, modulation may be applied to at least one of the AGC pulses, and or pseudo sync pulses and AGC pulses, in at least one horizontal blanking interval, to provide the dynamic oversaturation of the colors.

Another embodiment of the invention applies a color stripe signal or color burst modification to one or more TV lines in the C channel to provide, along with the luminance copy protection signal, a static or dynamic saturation or oversaturation of hue or tint errors in the video signal of a recorder or in an illegal copy of the video signal.

Optionally, in another embodiment, an enhancement signal can be applied in the luminance channel, such as lowering a back porch portion in one or more lines and or reducing an amplitude of one or more sync pulses, to cause an AGC system to increase luminance signal amplitude. This results in a relative lowering of the color saturation effect, i.e., color de-saturation, because of the unaffected chroma signal.

To illustrate, if the pseudo sync and or AGC signals are decreased essentially to zero level, the lowering of a back porch on selected lines, or reduced sync amplitude on selected lines, causes an abnormally increased video level in the luminance channel. This greater luminance level then causes a mismatch with the amplitude of the chrominance channel's signal, which leads to color de-saturation in the signal output from the AGC system of a video recorder.

Alternatively, if the copy protection signals are modulated with the enhancement signal example described above, the luminance signal amplitudes will range from abnormally high to abnormally low. The luminance level range of abnormally high to abnormally low, when combined with an unaffected chroma channel's amplitude, results in a display of abnormally de-saturated colors to abnormally saturated colors. Should the chroma channel include a color burst modification such as a color stripe signal or partial color stripe signal, a recorder will exhibit a range of less effective tint errors to intense tint errors. So there will be a larger or increased range of color tint error effects with the application of the previously described enhancement signal with, for example, a modulated or dynamic copy protection signal and a color stripe or partial color stripe signal.

It is understood that an enhancement signal may include an AGC level that goes below a nominal blanking level, such as a range of minus 1 to minus 20 IRE, to cause an abnormally higher video level from an AGC system. Such an AGC system as, for example, in a video recorder's input/output system or record/playback system. For example, amplitude modulated AGC pulses can range within levels of −20 IRE to +150 IRE.

It is noted that applying a lowered back porch (or AGC pulse), or reduced sync signal, in a video signal will cause the AGC system to increase video output abnormally in a Y/C video signal system, or in a composite video signal system. In the case of a composite video signal, the video amplitude is greater than a normal level, which includes luminance and chrominance levels that are abnormally high. When the AGC pulses also are modulated (in amplitude, position, and or pulse width), the range of video levels is greater than without applying a lowered back porch (or AGC pulse) or reduced sync signal. Thus a more effective copy protection effect is provided by this greater range of video levels.

Thus, it is an object of the invention to provide for varying degrees of chroma copy protection effects from a media player or recorder. For example, varying a level shifting voltage so as to change the gain or pedestal effect from an AGC amplifier in a video recorder.

Another object of the invention is to allow programming of various luminance copy protection signals to provide one or more chroma effects when an illegal copy is made via a video recorder. For example, a modified color stripe signal with level shifting in the back porch area generates less noticeable color distortion on an illegal copy than a color stripe signal without the (negative) level shifting in the back porch area.

Another object is to provide a chroma copy protection effect via a luminance copy protection signal, which causes increases in brightness and or erroneous scan problems on an illegal copy.

A further object of the invention is to control (e.g., via programming a (signal) waveform to provide) an unexpected oversaturation or abnormal chroma level caused by a luma attenuation effect in an AGC system or video recorder to provide varying effects of a copy protection signal.

As previously discussed, in an S-Video connection, the AGC effects of a recorder with S-Video input(s) affect the luma channel but not the chroma channel. That is, the chroma channel is not affected by the recorder (circuits). Thus, the varying luma amplitudes do not track the stable chroma amplitudes when a copy protection signal includes modulation of the AGC and or pseudo sync pulses. During maximum attenuation of the luma channel caused by AGC pulses, the chroma signal is unaffected (e.g., chroma not attenuated), thus causing an oversaturation effect on a displayed or recorded signal.

Alternatively, another object of the invention is to reduce the dynamic chroma copy protection effects of the copy protected video signal, such as caused for example by the techniques of the invention described above. Reduction of the chroma effects may include setting the AGC pulses to a fixed level, which reduces the dynamic chroma copy protection effects.

Still another object of the invention is to restore the color saturation to a more normal balance by reducing the effects of a level shifting signal in a copy protection signal. Such a signal, for example, lowers an area in the back porch region in active lines, while providing a substantially normal back porch level in selected vertical blanking interval lines. The level shifting voltage in the negative direction causes some recorders and or TV sets to increase contrast or to change overall brightness, which in turn changes the color saturation of the content.

Another object of the invention is to provide a circumvention device (e.g., black box) for preventing the disparity between the luma and chroma signals in a copy protected component video signal, to improve chroma playability in a copy protection signal. The effects of the circumvention device varies whether done in a composite signal or a component signal (Y/C or S-Video) environment.

A further object of the invention is to provide a circumvention device which modifies the effects of a color stripe copy protection signal by modifying a luminance portion of the video copy protection signal. The effects may include dynamic or time varying color distortion.

Yet another object is to provide a different circumvention effect in a composite video signal then in an S-Video signal (Y/C).

Another object of the invention is to circumvent oversaturation or de-saturation, e.g., abnormal chroma level, by selectively modifying a luma video signal containing one or more copy protection signals, to remove or reduce the effects of the copy protection signals.

### BRIEF DESCRIPTION OF THE DRAWINGS

FIG. 1A is a block diagram illustrating a prior art AGC system for use with a composite video signal.

FIG. 1B is a block diagram illustrating a prior art AGC system for use with a luminance component video signal used typically in an S-Video system.

FIG. 1C is a block diagram illustrating a prior art amplifier for use with a chrominance component video signal used typically in an S-Video system.

FIG. 2A is a waveform illustrating an effect of an AGC pulse on a composite video signal.

FIG. 2B is a waveform illustrating an effect of an AGC pulse on a luminance component video signal.

FIG. 2C is a waveform illustrating a constant output of a chrominance component video signal.

FIG. 3 is a block diagram illustrating an embodiment of the invention, wherein the invention resides in the blocks denoted as Yproc and or Cproc.

FIG. 4A are waveforms illustrating an effect of AGC pulses on a component video signal such as Y and C, where ROS is the Relative Overall Saturation.

FIG. 4B are waveforms illustrating an effect of AGC pulses on a composite video signal such as in the NTSC or PAL video standard.

FIG. 5A is a waveform illustrating the blanking level of a video signal.

FIG. 5B is a waveform illustrating a modified blanking level of a video signal.

FIG. 6A is a waveform illustrating a typical video level output from an AGC system with normal blanking levels.

FIG. 6B is a waveform illustrating an abnormally higher video level output from an AGC system with modified blanking levels.

FIG. 7A is a waveform illustrating a time dependent effect on the luminance amplitude of an AGC system caused by a modulated or dynamic copy protection signal.

FIG. 7B is a waveform illustrating a time dependent effect on the chrominance amplitude of an AGC system caused by a modulated or dynamic copy protection signal.

FIG. 7C is a waveform illustrating a typical AGC effect in modulated copy protection signals.

FIG. 7D is a waveform illustrating modified transition times in AGC effects in modulated copy protection signals.

FIG. 7E shows an example waveform of modulating AGC pulses.

FIG. 7F shows another example waveform for modulating AGC pulses.

FIG. 7G shows an example of non symmetrical slopes or transition times.

FIG. 7H shows an example of non linear slopes or transition times.

FIG. 7I is a block diagram illustrating a typical system for use in a digital video signal.

FIG. 7J is a block diagram illustrating an AGC pulse modulator, for example, for the circuit of FIG. 7I.

FIG. 8A is a block diagram illustrating a modifying apparatus for a circumvention device which reduces or defeats erroneous chroma saturation.

FIG. 8B is a block diagram illustrating a replacement apparatus for a circumvention device.

FIG. 8C is a block diagram illustrating a level shifting apparatus for a circumvention device.

FIG. 8D is a block diagram illustrating a burst modifier apparatus for a circumvention device.

FIG. 8E is a block diagram illustrating a blanking apparatus for a circumvention device.

FIG. 9A is a block diagram illustrating apparatus for circumventing erroneous chroma saturation in accordance with the invention.

FIG. 9B is a block diagram illustrating another apparatus of the invention for reducing or defeating erroneous chroma saturation.

### DETAILED DESCRIPTION OF THE INVENTION

Providing a Copy Protection Signal for Increasing Chroma Saturation Effects

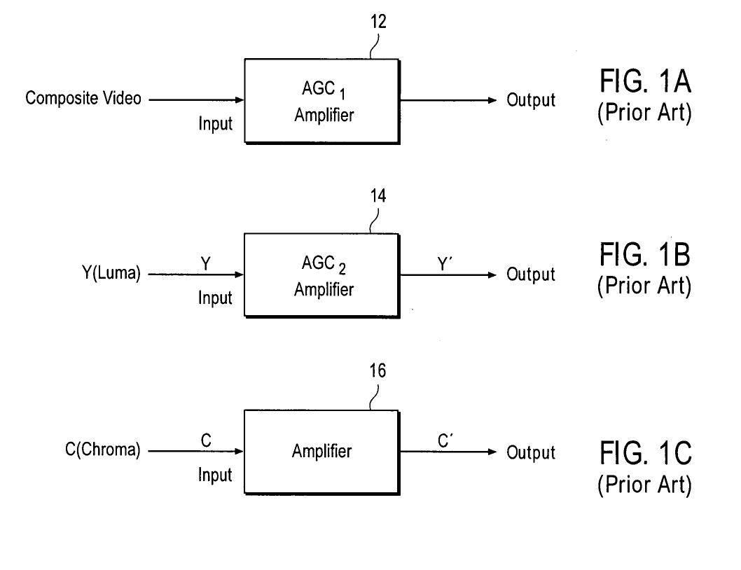

FIGS. 1A and 1B illustrate respective automatic gain control (AGC) amplifiers 12 and 14, which typically measure the difference in voltage levels from a sync pulse tip voltage to a level following the trailing edge of the sync pulse. Usually the level following the trailing edge of the sync pulse is a normal blanking level such as 0 IRE. Should the blanking level be altered in a sufficient number of TV lines, or should a sufficient number of pulse pair signals comprising pseudo sync and AGC pulses be added to the video signal, an erroneous signal at the output of the AGC amplifier 12 or 14 will result. For example, raising a portion of the back porch area in sufficient lines will cause the AGC amplifiers 12 and 14 (AGC1 and AGC2) to output a lower than expected signal. Conversely, lowering a back porch area, or providing a reduced sync pulse amplitude, in sufficient lines will provide an opposite effect of providing a higher than expected signal level output from the AGC amplifier.

The AGC amplifiers 12, 14 shown in FIGS. 1A and 1B tend to peak and hold the highest detected value, with a slow discharge to a lower value. For example, if there are 40 or more video lines, or 15% of lines, with an abnormally high blanking level such as 100 IRE instead of a normal level of 0 IRE, the AGC amplifier will adjust to lower the output of the AGC amplifier as if all of the lines had the abnormal blanking level. This is found to be particularly true when the abnormal blanking level, for AGC pulse amplitude/level, is near or around peak white level. Also, if there are 40 or more pulse pair signals with the associated AGC pulses near peak white level added to the video signal (e.g., in the VGI), then an AGC amplifier will react similarly as mentioned above. For example, the AGC amplifier attenuates the signal as if the blanking level on all lines in the back porch is raised to peak white.

FIG. 1C illustrates a chroma amplifier 16 in an S-Video system (e.g., SVHS), which does not have an AGC system when measured from input to output in the Record EE mode (EE mode=electronic to electronic mode).

However, it was found that in the record-playback mode (for example, in a VCR), there is an AGC amplifier in the chroma channel. Accordingly, in the record and playback process, the AGC amplifier measures the amplitude of the color burst signal in the horizontal blanking interval.

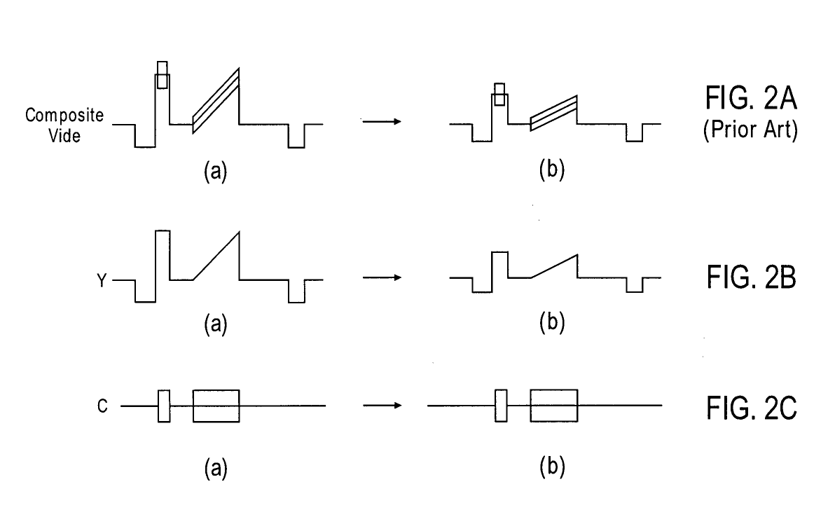

FIGS. 2A(a) and (b) illustrate a typical attenuation effect on a video signal at an output of an AGC system when AGC pulses or pulse pairs are applied to the input of the (AGC) amplifier. FIG. 2A(b) shows a lower amplitude composite video signal from the output of an AGC system.

FIGS. 2B(a) and (b) illustrate a similar effect on a component video signal (Y/C) when an AGC pulse is applied to the input of an AGC system for an S-Video signal. The FIG. 2B(b) shows the attenuation on the luminance channel, Y.

FIGS. 2C(a) and (b) illustrate that even though the luminance channel is affected (see FIG. 2B), the chrominance channel is not. That is, the chrominance signal is not attenuated by a recorder and thus the chroma channel functions independently with respect to the luminance channel in terms of automatic gain control.

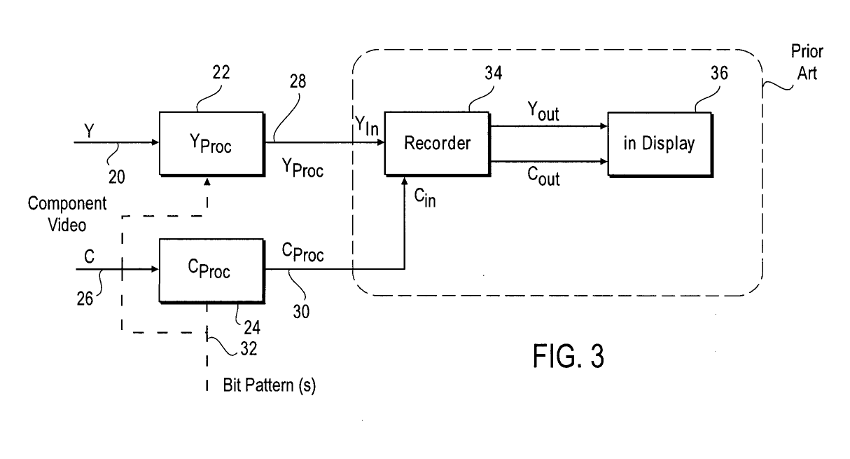

FIG. 3 illustrates an embodiment of the invention, wherein a component video signal Y/C is supplied to a Y/C system. A luminance signal Y is supplied via an input 20 to a luma processor 22 (Y proc). One or more copy protection signals or enhancement signals are inserted or added to the luminance channel via the luma processor 22 (Yproc) to provide an overly saturated color image on a display device, that is coupled to a recorder. The copy protection signals may include AGC pulses, pseudo sync pulses (see, for example, U.S. Pat. No. 4,631,603 to Ryan, which is incorporated by reference), and or horizontal blanking interval (HBI) AGC pulses (see, for example, U.S. Pat. No. 4,819,098 to Ryan, which is incorporated by reference). Enhancement signals may include lowered back porch or reduced amplitude sync pulses, to provide a de-saturated color image on a display device coupled to a recorder, by causing the luminance signal level to be abnormally high while providing substantially a normal level of the chroma signal.

Also shown in FIG. 3 is a chroma processor 24 (Cproc), receiving a chroma signal via input 26, which includes color burst phase modifications such as adding/inserting one or more cycles of incorrect phase (angle) subcarrier in one or more horizontal blanking interval. Alternatively, input 26 may be replaced with color difference signals such as Pb, Pr, (R-Y), (B-Y), I, Q, U, V, etc., and chroma processor 24 may include a color subcarrier encoder (e.g., two phase multiplier system such as I, Q, modulation) to provide a color burst or modified (phase) color burst signal. The signal on input 26 (or 20) may include digital signals and processor 24 (or 22) may include a digital to analog converter. The color burst phase modification may include a whole or partial color stripe signal (such as described in U.S. Pat. No. 4,577,216 to Ryan, U.S. Pat. No. 7,039,294 to Quan/Ryan, and U.S. Pat. No. 6,516,132 to Wrobleski/Quan, wherein the three patents are incorporated by reference), and or a shortened or augmented duration color burst envelope. When a burst phase modification of a Cproc output 30 is combined with a Yproc output 28, the resulting copy protection effect includes an oversaturated hue shift error. That is, the chroma copy protection effect is intensified in a Y/C mode when compared to a chroma copy protection effect in a composite signal, because in a Y/C mode the color tint errors (hue shift errors) are exaggerated, for example, via increased color intensity/saturation of the hue or phase errors.

The outputs Yproc and Cproc from the Yproc 22 and Cproc 24, respectively, are supplied via leads 28, 30 to for example a video recorder 34, whose outputs Yout and Cout are supplied in turn to a display device 36.

It can be shown, given the basic equations of Y=59% green (G)+30% red (R)+11% blue (B), and with the color difference signals encoded in the chroma channel C being R-Y and B-Y, that a color de-saturation is cause by a level shifting up of the R,G, and or B channels that drive the display (e.g., CRT or LCD). Similarly an over saturation effect occurs when the R,G, and or B channels are level shifted down.

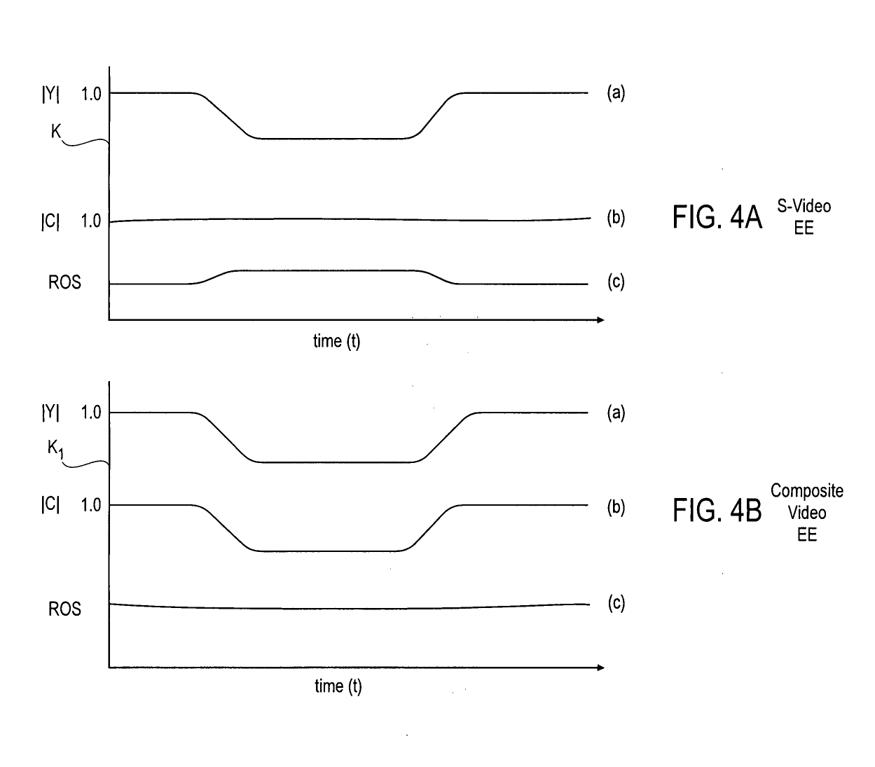

FIG. 4A shows the effects on the overall picture's color saturation in terms of time when the luminance signal is varying in amplitude over time due to modulated AGC or copy protection pulses. Here, for example, when the AGC pulses (or associated AGC pulses with pseudo sync pulses) are varied from 0 IRE to a gray or white level for the Y channel, FIG. 4A(a), the recorder with an S-Video input will cause only the Y channel to modulate in video level or gain, while leaving the C channel unchanged in (chroma) video gain, FIG. 4A(b). As a result, the relative overall color saturation of the display (ROS), FIG. 4A(c), is modulated to an increased and abnormal color saturation as the AGC pulses or copy protection pulses are increased in effectiveness or in amplitude. Since the AGC pulses or copy protection pulses may be modulated from a gray or white level to a blanking level, for the AGC pulses may be position and or pulse width modulated, the overall color saturation will vary from abnormally high saturation to normal saturation.

Not shown in FIG. 4A is the embodiment wherein the video signal includes AGC pulses and also a lowered back pulse level and or reduced amplitude sync level. This combination causes an abnormally higher luminance level when the AGC pulses are at a blanking level which causes the overall color saturation to vary from a de-saturated color to abnormally higher saturation, and vice versa, as the AGC pulses are modulated.

It is noted in FIG. 4A, the variance in color saturation is caused by the mistracking of luma and chroma levels/gains as the AGC pulses or copy protection pulses are modulated. In contrast, FIG. 4B shows a composite video system with modulated AGC pulses or copy protection pulses, and here, the color saturation remains substantially constant because both luminance and chrominance levels/gains are tracking. See FIG. 4B(a) and 4B(b). Thus, the relative overall saturation (ROS) is constant, as shown in FIG. 4B(c).

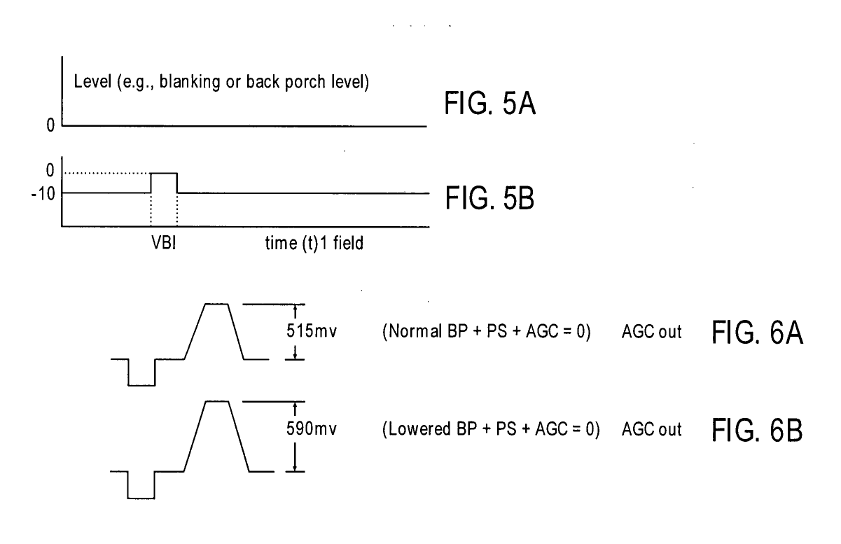

FIG. 5B shows an example of how a reduced amplitude in sync pulse(s) or a lowered level (e.g., −10 IRE) of a portion of a selected back porch in selected (e.g., active and/or overscan area) TV lines, along with normal backporch levels or normal sync amplitudes in one or more lines in a vertical blanking interval, for example, in selected lines of a vertical blanking interval of 0 IRE blanking level or 0 IRE sync amplitude, can be used to affect an AGC system. FIG. 5A shows a “normal” blanking level of 0 IRE and normal sync amplitude level (−40 IRE) for all TV lines.

Generally, it is found that the peak level, that is, the highest level measured from sync tip to a duration shortly after the trailing edge of sync, will determine the AGC system's sample voltage, given at least 30 or more samples per field. In the example in FIG. 5B, the vertical blanking interval (VBI) includes 32 pseudo sync pulses along with about 26 sync pulses of normal amplitude or back porch level, for a total of about 56 samples of normal level (e.g., magnitude of 40 IRE) in the VBI. Also in FIG. 5B, there are lowered back porch levels or reduced amplitude syncs for the active field, which amounts to about 240 samples of a reduced level (e.g., magnitude of 30 IRE or <40 IRE).

Past experiments for observing AGC pulses (100 IRE) wherein the level after a pseudo sync and or horizontal sync was 100 IRE, showed that only 40 AGC pulses per field were sufficient to cause the AGC system in a recorder to behave as if the incoming video signal had a blanking level of 100 IRE for all 262 lines per field. Thus, in the video signal, the other 222 TV lines having normal 0 IRE were not sensed in the presence of the 40 AGC pulses.

In the example above, there are 56 lines/samples for the AGC system of a normal (amplitude) level (40 IRE), which should be sufficient to cause the AGC system to adjust the video to a normal level in spite of the 240 lines/samples per field of lower (amplitude) level (e.g., <40 IRE or about 30 IRE). But experiments show that this is not the case. Because there are 240 samples of <40 IRE amplitude, it turns out that it was observed directly on an AGC system, that the video level was actually increased by about 15%, which is abnormally high.

The results of the experiment are shown in FIGS. 6A and 6B. In FIG. 6A, the AGC pulses are turned off to 0 IRE, with pseudo sync pulses in the VBI, for a total of 56 syncs/pseudo sync/samples per field that have normal amplitudes and normal back porch blanking levels. This signal is coupled to a VCR (for a composite or component signal input), which has an AGC amplifier. The output of the VCR (for composite or component output) has the amplitude of the active video line at 515 millivolts.

In FIG. 6B, the video signal is a modified version of the signal in FIG. 6A. The VBI is unchanged with the same 56 syncs/pseudo sync/samples of normal amplitudes and normal back porch levels. But in 240 active TV lines, the horizontal sync amplitudes and or back porch levels are lowered (e.g., H sync is lowered from 40 IRE to 30 IRE). The result of the lowered sync and or back porch amplitudes causes a VCR to output a higher amplitude video signal of 590 millivolts as shown in FIG. 6B versus 515 millivolts measured without the lowered backporch or reduced sync level as shown in FIG. 6A.

Thus, when the AGC pulses have no effect or are effectively turned off, the AGC system inside a recorder will have an abnormally high video signal (e.g., luma signal in Y/C system, or composite signal in a standard NTSC, PAL, or SECAM system). When the AGC signals are turned on or engaged, the output of the video signal is lowered.

Thus, without the lowered blanking levels, back porch levels, or sync amplitudes, a dynamic AGC copy protection signal causes the AGC amplifier's output to range from normal video level to attenuated level. However, if reduced amplitude syncs and or lowered blanking levels or back porch levels are added to the dynamic AGC copy protection signal, the copy protection effects for an AGC system ranges from abnormally high level of video signal to attenuated level, or vice versa. Thus, the copy protection effect is enhanced by the increased range of contrast, brightness, and or video levels when a dynamic AGC copy protection signal is combined with a lowered back porch signal and or with reduced sync amplitude in selected lines.

A further embodiment of the invention may include a version where AGC pulses, which are normally set in the “off” level of 0 IRE, may be set below blanking level. Preferably, the below blanking level is no lower than −20 IRE (−20 IRE<AGC low level or minimum level <0 IRE), which would ensure proper sync separation of normal syncs (e.g., to ensure playability on a TV set). By setting the AGC pulses below blanking such as −10 IRE (±20%), the AGC system will output an abnormally high video signal. For example, an embodiment of the invention may include AGC pulses at a low state of about −10 IRE, to greater than 80 IRE for a high state. In general, AGC pulses may be in the range of −20 IRE to gray or peak white or greater than peak white.

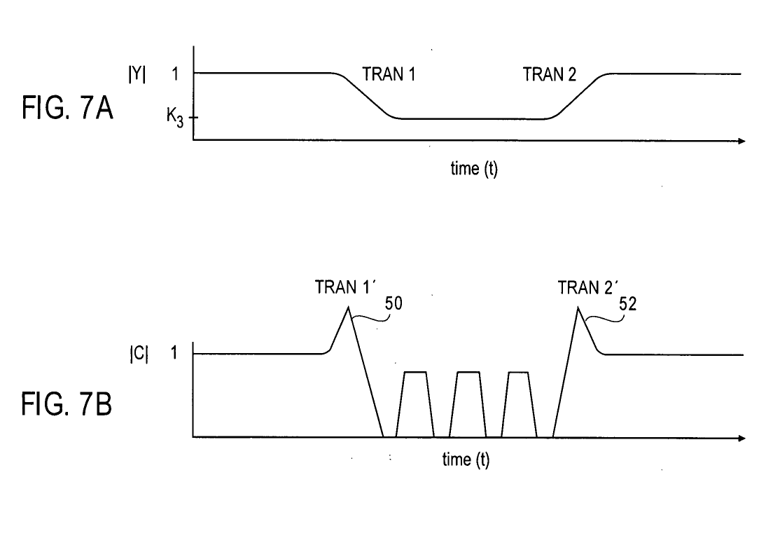

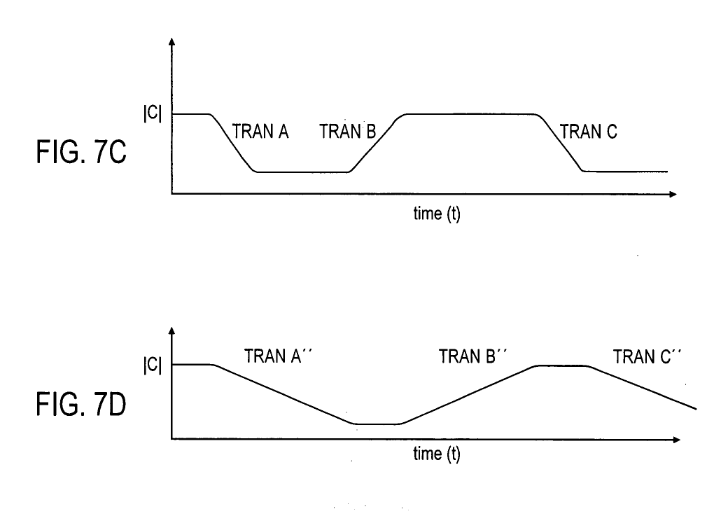

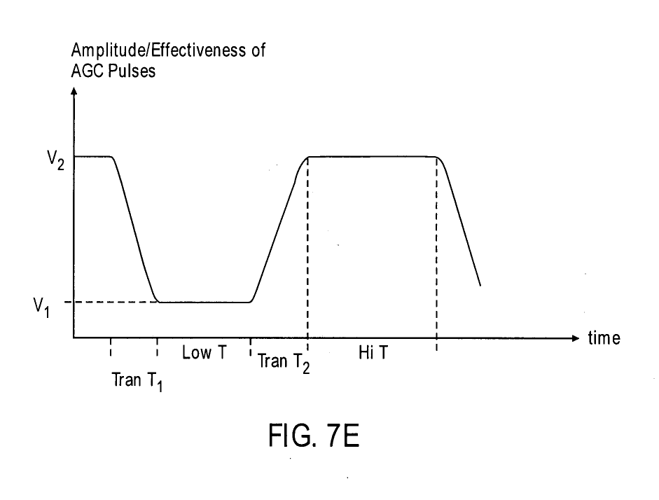

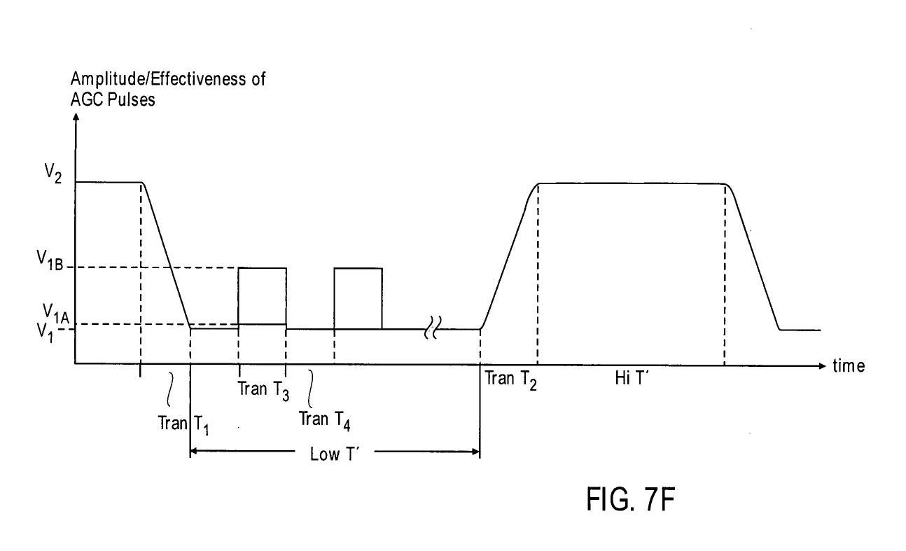

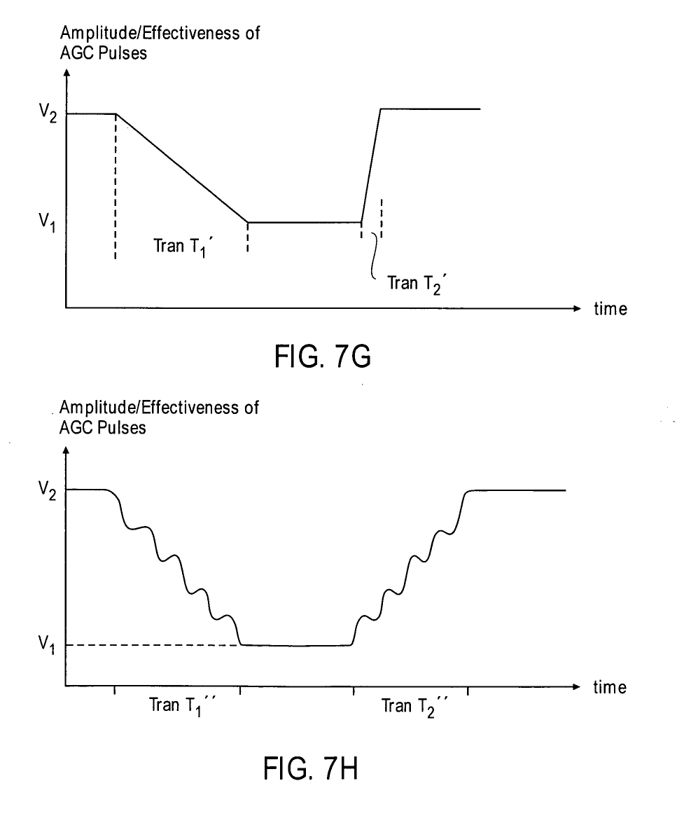

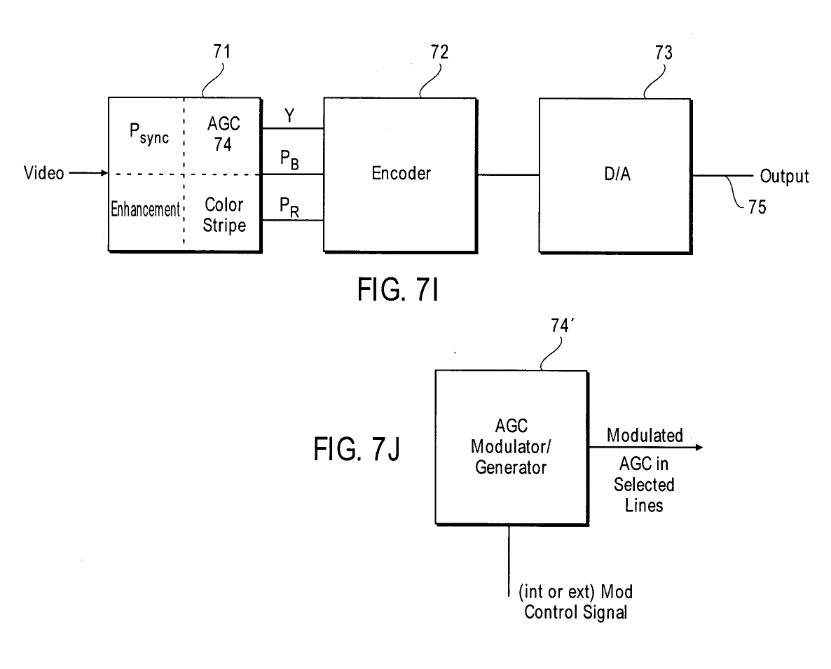

FIG. 7A shows the effect of modulated AGC pulses on a recording in a composite (or component) video signal. Here the luminance channel, Y, has a magnitude that varies from normal amplitude (AGC off) to a minimum amplitude (AGC fully enabled). The transition time or slope, Tran1 shows the amplitude going from normal to low, while transition time or slope Tran2 shows the amplitude “recovering” from low to normal amplitude.

However, when the chroma signal's amplitude is observed as depicted in FIG. 7B (e.g., in a composite video signal), it was found experimentally in a VCR that the amplitude actually peaked to an abnormally high chroma level during Tran1′ (see numeral 50) and Tran2′ (see numeral 52), which is unexpected. For example, the burst amplitude exceeded (in a transient manner) the normal 40 IRE or 300 millivolts peak to peak during the period when the luminance signal was being attenuated via the AGC pulses. Thus, an embodiment of the invention can include lengthening the transition time for Tran1 and or Tran2 to provide a longer time for the chroma level to become abnormally high. This then provides an enhanced chroma copy protection effect. Lengthening the transitions in time may be accomplished by a “slower” modulation of the AGC, pseudo sync, and or back porch pulses.

FIG. 7C illustrates a typical AGC effect in a chroma signal when copy protection signals are modulated. For example, the AGC pulses may be amplitude and or pulse width modulated in a stepped or a continuous manner. The transition from maximum to minimum modulation (of AGC pulses) is denoted by TranB, while the transitions from minimum to maximum modulation (of AGC pulses) are denoted by TranA and TranC (e.g., normal signal level to minimum/reduced signal level output). To increase the time of the oversaturation effect of the chroma signal to provide an enhanced chroma copy protection effect, FIG. 7D illustrates modified transition time(s) for lengthening the period or duration from minimum modulation to maximum modulation (and vice versa) for the copy protection signal. Minimum modulation may include a minimally (which may include zero) set pulse width and or amplitude of AGC and or sync/pseudo sync signals. Maximum modulation may include a maximally (which may include gray, peak white, or above peak white level) set pulse width and or amplitude of AGC and or sync/pseudo sync signals.

Thus FIG. 7D illustrates new longer transitions, TranA″, TranB″ and or TranC″, which provide an enhanced copy protection effect by causing increased chroma signal levels to occur for a longer period thus (further) impairing the entertainment value of an illegal copy.

FIG. 7E illustrates an example of different transition times to more effectively increase the period for chroma copy protection exhibited by oversaturation in absolute levels of chroma (e.g., see FIG. 7B) or oversaturation of relative levels of chroma (e.g., see FIG. 4A). In a prior implementation the transition time TranT1 and TranT2 or slope duration/period is 2.5 seconds ±500 milliseconds. By providing greater than 3 seconds of transition time from TranT1 or TranT2 (or TranA″, TranB″, and or TranC″, FIG. 7D), the chroma copy protection effect for oversaturation of colors or chroma signals (in absolute and or relative terms) is increased, improved, and or enhanced (e.g., by lengthening the tie that the oversaturation effect occurs). Note that a reduction of oversaturation effect may be provided by setting the transition time to less than 2 seconds. In other embodiments of setting the transition time, the transition time(s) of TranT1 or TranT2 (or TranA″, TranB″, and or TranC″, FIG. 7D) need not be equal, or the transition time (or slope) may be varied as a function of time. For example, a positive going slope transition may have <=3 seconds, while a negative going slope transition may have >3 seconds or vice versa. Generally TranT1 may have a transition time of T1 while TranT2 may have a transition time of T2, where T1=T2 or T1 not equal to T2.

FIG. 7F illustrates an alternative modulation embodiment. Here an intermediate level of effectiveness of copy protection is inserted by a series of periods where the AGC effect is less than maximum (e.g., AGC pulses set between 30% to 70% of maximum level or of maximum effectiveness). See TranT3. In prior art implementations, the periods of TranT3 are on the order of 1.0 second to 1.25 seconds. For an embodiment of the invention the periods may be extended to beyond 1.25 seconds to provide longer time of exposure for increasing chroma copy protection effects such as increase relative overall saturation or absolute increased saturation. Alternatively, TranT3 may be set to less than 1.0 sec to provide a quicker “spike” of modulated moderate copy protection effect(s). Or TranT3 may be set greater than 1.25 seconds as previously mentioned, to provide a longer period of partial effectiveness, which may actually cause more flickering in the chroma playback of an illegal copy.

Although a waveform similar to that of FIG. 7F has been used in 625 line systems, this waveform or one similar to it may be used in 525 (e.g., NTSC) or 240 line progressive line systems.

The waveform of FIG. 7E has been used in 525 line systems, but can now be used in PAL or SECAM or other 625 line or 50 Hz TV systems.

FIG. 7G illustrates an example where the transition times for modulating AGC pulses (or other) copy protection signals) may be asymmetrical. That is, the absolute value of the slopes during TranT1′ is not equal to TranT2′. Note that although the example shows a shallower slope for TranT1′ than TranT2′, another example can have the (absolute value) slope of TranT1′ steeper or greater than that of TranT2′.

FIG. 7H illustrates that modulation of the AGC pulses (or other copy protection signals) may be programmed to a signal more complex than a straight line or series of equal steps. Thus the transition period may include a predetermined waveform (e.g., different from a simple slope or simple stepped staircase waveform).

FIG. 7I illustrates a typical apparatus for processing a digital video signal. A digital video signal from a player, tuner, memory unit, etc, is coupled to a processor 71, which applies a lowered or raised pixel(s) in selected video lines. Processor 71 also includes a color burst modification that contains, on selected lines, one or more cycles of incorrect subcarrier phase in a selected horizontal blanking interval. The color burst modification typically includes a split burst color stripe signal and or an extended duration color burst signal (e.g., such as described in Patents No. U.S. Pat. No. 6,516,132, U.S. Pat. No. 5,784,523, and or U.S. Pat. No. 7,039,294, incorporated by reference). For AGC pulses, processor 71 may include modulated AGC pulses, which control the amplitude, position, and or width of these pulses in a static and or time varying manner. Also, processor 71 includes insertion of pseudo sync pulses. The output of processor 71 is coupled to an encoder 72. Encoder 72 provides an NTSC, PAL, or SECAM signal, or a lower resolution (e.g., 240 p, NTSC) analog signal or an output 75 via a digital to analog converter 73. Output signal 75 may be a composite, component (Y, Pb, Pr or R,G,B or equivalent), and or Y/C signal.

Thus, FIG. 7I (or 7J) exemplifies an apparatus for providing or generating signals such as AGC and or other copy protection waveforms which include the types of modulation and or transition or slopes described previously, in any combination of FIGS. 7E, 7F, 7G and or 7H (e.g., pertaining to modulating AGC pulses or modulating the effectiveness of AGC pulses).

FIG. 7J illustrates an example of an AGC pulse modulator. Typically the amplitude of AGC pulses are changed or modulated. However, modulation can include any combination of amplitude, frequency, width or duration, and or position modulation, such as for example, the signals described in U.S. Pat. No. 6,836,549 (which is incorporated by reference). In a digital example, the amplitude of the AGC pulses are stepped from a set of integers. These integers may represent the various levels of the AGC pulses. The “speed” of stepping through these integers may be implemented via a memory circuit, counter circuit, and or one or more clock frequencies. An internal or external control signal may set the “speed” of the stepping action or rise and or fall times of the AGC amplitude modulation. It is noted that the rise and fall times (e.g., slopes) may be unequal or equal, or may be a programmed waveform.

It should be noted that although FIGS. 7I and 7J imply conditioning the video signal in the digital domain, analog circuits (or processing in the analog domain) may be used to implement the copy protection signals mentioned, including modulating the AGC pulses.

Reducing the Effects of Erroneous Chroma Saturation in a Recorder or in a Chroma Copy Protection Signal

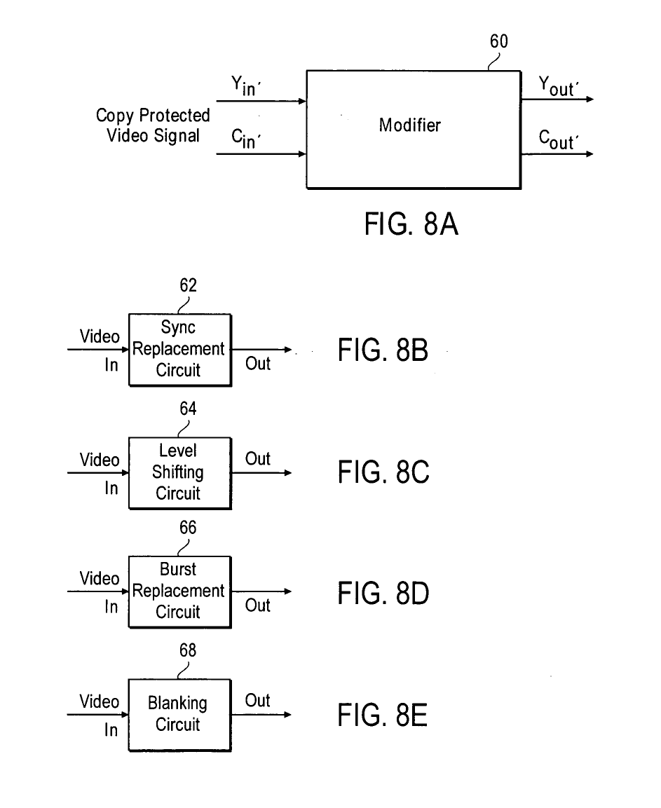

FIG. 8A illustrates a circumvention device 60 (commonly called a “black box”) with an input of component video signals Y and C. This device generally has a copy protected Y/C video source coupled to the inputs Yin′ and Cin′. The output of the circumvention device 60 Yout′ and Cout′ then is coupled to a recorder's input for Y and C (not shown), and the output of the recorder may comprise a composite signal or Y/C signal to be coupled to a TV monitor.

It should be noted that the recorder has three possible modes. One mode is recording and playing back, another is the EE (electronic to electronic) mode on “standby”, and third is the EE mode with the record switch enabled.

In some recorders, the standby mode includes an AGC system in the video output. In other recorders, the standby mode is a straight bypass mode. Thus, in a recording having an AGC system, the recorder will show AGC gain effects when a copy protected signal is used. If the standby mode is in a bypass mode, even a copy protected signal will have no AGC effects on the output of the recorder.

In most recorders, both the record playback mode and record EE mode respond to copy protection signals such as luminance gain changes (abnormal or subnormal video output signals).

Thus, a circumvention device as shown in FIG. 8A performs the following novel functions:

1) Removal/modification of copy protection signals in the Y channel to provide a correct luminance to chrominance signal level for the output of a recorder, wherein the recorder is subject to recording and playing back, is in an EE mode, or is in the EE mode with the recording function switch enabled.

2) Removal/modification of copy protection signals in the Y channel wherein the copy protection signals have a modulated AGC, pseudo sync, and or sync signal to provide dynamic or time varying copy protection effects (e.g., time varying signal levels of the luminance channel), to cause removal or reduction in time varying oversaturation of colors on a display. In this situation, the recorder's video output is coupled to an input of a display and is subject to recording and playing back, is in an EE mode, or is in the EE mode with the recording function switch enabled.

3) Removal/modification of copy protection signals in the Y channel while not modifying or removing a chroma copy protection signal such as a one or more color burst modification in phase (e.g., color stripe, partial color stripe), to provide a less intense color saturation of the color tint errors (e.g., less intense color banding) caused by the color burst phase modification, wherein the recorder is subject to recording and playing back.

4) Removal/modification of modulated or dynamic copy protection signals in the Y channel while not modifying or removing a chroma copy protection signal such as a one or more color burst modification in phase (e.g., color stripe, partial color stripe). This provides less varying color saturation or a constant saturation of the color tint errors (e.g., less intense color banding) caused by the color burst phase modification, wherein the recorder is subject to recording and playing back. Without the removal or modification of the modulated or dynamic copy protection signals (e.g., amplitude, pulse width modulated, and or position modulated AGC, pseudo sync, and or sync signals), a time varying color saturation of the color banding occurs. Removal/modification of the modulated or dynamic copy protection signal may include providing an un-modulated or static copy protection signal. For example, AGC pulse(s) (or sync or pseudo sync pulses) may be of a fixed or static level/amplitude and or may be of fixed position and or pulse-width.

5) Restoring or replacing to a normal level a lowered back porch level or sync pulse present in a copy protected video signal in the Y channel, to provide a correct luminance to chrominance signal level for the output of a recorder (for a normal color saturated picture on a display), wherein the recorder is subject to recording and playing back, is in an EE mode, or is in the EE mode with the recording function switch enabled. Without the restoring or replacing step, the video signal through a recorder would show a de-saturated picture. It is noted that lowering a back porch or reducing amplitude of selected sync pulses causes some recorders to increase luminance output, thereby causing higher levels of luminance signals with normal chrominance levels, which results in a de-saturated picture.

FIG. 8B illustrates a sync replacement circuit or device 62 which replaces or regenerates sync (H and or V). Video is coupled to the input of the sync replacement circuit 62, which may include a sync separator and a pulse generator (not shown) to form newly regenerated H and or V syncs. At the output of the circuit 62, the newly generated sync pulses are inserted in selected lines and selected blanking intervals. For example, some or all of the sync pulses may be replaced at a nominal or normal level (e.g., amplitude of 40 IRE or 300 millivolts peak to peak), or at a level greater than one or more incoming sync amplitudes. In general, a copy protected video signal has about 30 RE of sync level, and the sync replacement circuit or device 62 of FIG. 8B provides a greater than 30 IRE amplitude, such as a 40 IRE (normal) amplitude for the (selected) syncs.

The sync replacement circuit 62 of FIG. 8B may replace the sync pulses in the digital domain. Here, the copy protected video signal, with typically lowered back porch in selected lines and or reduced sync pulses (e.g., in a portion of the active field), is coupled to the circuit 62 of FIG. 8B, which now includes an analog to digital converter (not shown). In the digital domain, new back porch levels (e.g., zero IRE or zero black level or normal blanking level) and or sync pulses (e.g., 40 IRE or 300 millivolts) are inserted in selected line and pixel locations. Then a digital to analog converter (not shown) provides an analog video signal with modified back porch and or sync pulses (e.g., normal or standard 0 IRE back porch levels and or a sync amplitude of 40 IRE or equivalent level).

In some cases, the sync replacement circuit 62 also replaces the horizontal blanking interval (HBI) with a normal back porch level even though the copy protected video signal may include some AGC pulses in the HBI, or vertical blanking interval (VBI). Thus, the removal/blanking/modification of at least one AGC or pseudo sync pulse in the HBI (or VBI) in a copy protected signal (in the Y channel) allows for an improved luminance and chrominance proportion for improved color accuracy in saturation.

An alternative embodiment of the sync replacement circuit 62 of FIG. 8B may include a sync generator circuit (not shown), which is locked to the incoming copy protected video signal. The regenerated sync pulses from the sync generator circuit are inserted or switched in during blanking intervals while passing substantially the program video signal in one or more active portions of the (outputted) video signal.

In any of the embodiments described above for the sync replacement circuit 62, the Y channel is modified to return the ratios of the luminance to chrominance component signals to normal, that is, to restore the color saturation effect to normal when the output of the circumvention device is coupled to a recorder, or recorder and display. It should be noted that even when the AGC pulses do not have an attenuating effect on an AGC system, e.g., the AGC pulses are at zero or near zero amplitude, the replacement circuit or circumvention device restores the color saturation to normal.

Furthermore, by modifying or removing the effects of a basic copy protection process, such as removing AGC and or pseudo sync pulses, the chroma effects of the color stripe signal are reduced. This is particularly true when, for example, amplitude, pulse width, or position modulation of the AGC, sync, and or pseudo sync pulses is provided in the copy protected video signal. The modulated chroma effects of color band saturation changing in intensity is reduced or removed when the luminance channel is processed to remove signal(s) or effect(s) of the AGC, pseudo sync, or modified sync (e.g., narrowed sync) pulses.

FIG. 8C illustrates a level shifting circuit 64 which exemplifies another technique for modifying the luminance channel via level shifting a portion of the video signal. Here the level shifting circuit 64 may shift one or more pseudo sync tip level, to evade sensing the pseudo sync pulse by a sync separator circuit. Thus the pseudo sync-AGC attenuation effect is modified, reduced, or at least substantially eliminated in such a way as to reduce chrominance imbalance with the luminance signal, or to reduce modulated chroma effects should the AGC pulses be modulated.

Level shifting may occur in a portion of the pseudo sync and or AGC pulses so as to reduce the energy of the pulses. Such reduction in energy level of any of these pulses contributes to a reduction of AGC effects, which in turn provides a reduction of chroma saturation error.

Level shifting may be applied to a portion of the back porch. For example, if the copy protected signal includes a lowered back porch portion, which causes a Y/C component input recorder or composite input recorder to increase level to the output in terms of active video signal, then restoring at least portion of the backporch to a level higher than the lowered back porch level, will cause a recorder to output a more normal amplitude level. For example, to avoid overmodulation in an AGC system or VCR during the period when AGC pulses are at minimum or zero effectiveness for attenuation, a circuit should be replacing, raising, or level shifting a portion of the back porch in selected lines, or replacing in selected lines syncs of normal level (or syncs of higher than normal amplitudes such as >40 IRE)

Level shifting may be implemented by biasing a voltage in a portion of the video signal. In one embodiment, the biasing voltage or current provides an increase in a portion of the video signal, such as in a portion of the back porch. This biasing voltage is turned on for selected lines and pixels to offset at least one line in which a lowered back porch signal occurs, or where a pseudo sync pulse occurs.

Level shifting may be implemented by biasing a voltage that lowers a level, such as lowering a level of an AGC pulse.

In the digital domain, level shifting occurs after the copy protected video signal is represented as a series of discrete time numbers. Once in the digital domain, for selected pixels and or lines, a biasing voltage via a numerical representation is inserted or added to the digital signal to provide a “biased” level in the digital domain. When the digital signal is converted via a digital to analog converter, the analog output provides a bias voltage level to offset a lowered back porch portion of the copy protected video signal, to offset one or more pseudo sync tip, or to offset an AGC pulse.

FIG. 8D illustrates a burst replacement circuit 66, which replaces a portion or portions of a color burst with a more correct subcarrier phase in the HBI of selected lines. Generally, color bursts in a majority or all of the lines in the active field are replaced via a (new) subcarrier generator circuit. This circuit may require a C channel or composite video channel, which is in analog form. The circuit 66 may include an ADC (analog to digital converter), which may then re-encode in the digital domain new signals in the HBI to provide color burst signals of substantially normal phase subcarrier via a DAC (digital to analog converter). The ADC or DAC is not shown. As a result, dynamic saturation effects of hue errors are eliminated when a modulated AGC copy protection process is present in the input video. FIG. 8D may be combined with any circuits illustrated in the circuits of FIGS. 8A, 8B, 8C, and or 8E.

One embodiment of FIG. 8D may include a digital encoder (not shown) to convert component signals R-Y and B-Y, or equivalent component signals (e.g., I, Q, U, V, R, G, and or B), into a color subcarrier signal. In the HBI, the color subcarrier signal will be essentially free of incorrect phase signal(s), which then provides removal of dynamic color band distortion when a dynamic copy protection signal is provided in the luminance channel.

Alternatively, the color burst replacement circuit of FIG. 8D may be used to truncate a portion of the color burst signal (e.g., one or more cycles of incorrect color burst) to allow for removal of dynamic color band distortion when a dynamic copy protection signal is provided in the luminance channel.

Thus, in general, FIG. 8D illustrates a circuit that receives a video signal from a video source, and includes a timing generator (not shown) to control a subcarrier generator (not shown) to insert or replace, in selected lines and selected pixels, substantially normal phase subcarrier in one or more horizontal blanking intervals. Additionally, the circuit 66 may truncate color burst envelopes in the active field via a blanking circuit or switching circuit (not shown), to provide a removal of dynamic color band distortion from a recorder, or recorder and TV display.

FIG. 8E illustrates another embodiment of the invention wherein a blanking circuit 68 is used to insert a new blanking level in selected lines and pixels of an incoming video signal. A video signal with a lowered front and or back porch level, causes an abnormally high video signal level in an AGC system (e.g., a video recorder). Thus, FIG. 8E generally comprises a sync separator and a timing circuit (not shown). The timing circuit generates one or more signals to replace one or more levels in the back porch and or front porch of the incoming video signal. The blanking circuit 68 of FIG. 8E may be implemented in the analog and or digital domain.

In the digital domain, the circuit 68 includes an ADC and a circuit to replace or regenerate blanking levels via one or more bit pattern(s). The replaced blanking level is combined with the digitized program video signal and converted back to an analog signal via a DAC. The resulting output of circuit 68 then includes generally a correct blanking level of substantially 0 IRE or equivalent, which then offsets one or more effects in the input video signal with a lowered back porch level. These effects include, for example, restoring correct color saturation in a video recorder and a display, and/or reducing overmodulation of an AGC system such as an AGC amplifier prior to an FM modulator or an ADC in a recorder.

Generally, a switching or inserting circuit provides the correct or standard front porch and or back porch level at the output of the blanking circuit 68 of FIG. 8E. It is noted that although blanking level is generally set to 0 IRE or equivalent, other blanking levels that are above the incoming video signal's blanking level may be set. For example, if selected lines of the incoming video signal are set at −10 IRE, the blanking circuit 68 may replace one or more of those selected lines from −10 IRE to −5 IRE, or greater than −10 IRE.

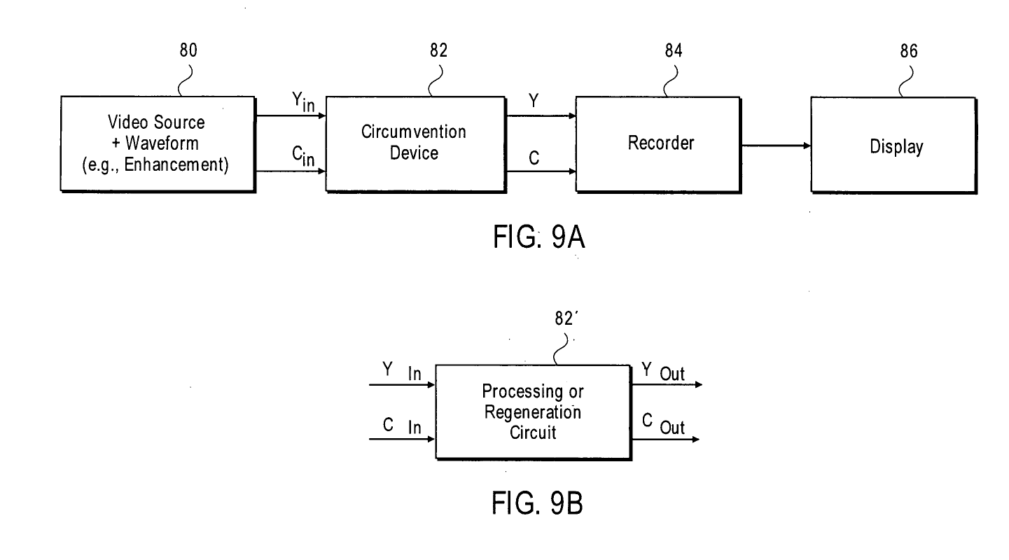

FIGS. 9A and 9B are block diagrams illustrating examples of method and apparatus for circumvention of the copy protection signals so as to reduce or defeat chroma copy protection effect(s), such as those of previous description.

FIG. 9A illustrates a video source 80 of a video signal with typical copy protection signals such as AGC pulses and or a color stripe signal, or an enhancement signal such as lowered back porch or reduced sync that may be combined with a color stripe signal. An embodiment of the invention includes a circumvention device 82, which has component signal inputs Yin and Cin and outputs Y, C. The outputs Y, C, may be coupled to a recorder 84, which has an AGC system. The output of recorder 84 is then coupled to a display 86.

As stated previously, for video recorders with component inputs the AGC effect on the Y channel does not migrate into the C channel. Thus, the circumvention device 82, by replacing or regenerating a portion of the video in the Y channel such as by removing at least one AGC or pseudo sync signal, will allow a monitor (display 86) to display normal saturation as opposed to oversaturation or de-saturation. Without the circumvention device 82, the AGC and or pseudo sync pulses will cause a luminance attenuation effect on the Y channel via the recorder 84 AGC system, while providing no corresponding attenuation on the chrominance channel from recorder 84.

In some cases the AGC pulses supplied by video source 80 are modulated, which causes a recorder to provide modulated color saturation effects on the display 86 if the circumvention device 82 is not present. Thus, a circumvention device that removes or modifies AGC or pseudo sync pulses, will reduce dynamic oversaturation of colors on the display 86 when in an EE or record/playback situation with the recorder 84.

Should video source 80 include an enhancement signal, such as a lowered back porch signal or reduced sync amplitude, the circumvention device 82 will restore color saturation to normal when the signal is viewed on the display after passing through recorder 84. The circumvention device 82 also will remove an overmodulation effect of the FM modulator in some video recorders. The overmodulation effect is caused by the reduced sync amplitude and or lowered back porch signal, and the circumvention device restores the proper sync amplitude or back porch levels which in turn causes the AGC system in the recorder 84 to adjust so as to provide a correct or normal level to the FM modulator.

In other embodiments, the video source 80 may include a lowered back porch signal or reduced sync amplitude level in the Y channel combined with a color stripe signal in the C channel (for example, color burst modification or one or more cycles of subcarrier in an HBI with incorrect phase). When this type of signal is fed to a recorder directly, such as to recorder 84, the color stripe copy protection effect(s) is (are) diluted because the Y channel will cause recorder 84 to provide a abnormally higher level of luminance with respect to the normal level of chrominance. However, if the circumvention device 82 is used, an unexpected result occurs. The circumvention device 82 removes or restores the sync amplitude level to normal amplitude or restores the correct back porch level, which will cause recorder 84 to output a normal level of luminance. Thus, the display 86 will display more color saturation of the color stripe effect wherein, for example, a color stripe effect causes hue errors in bands or segments of the TV field.

FIG. 9B illustrates an example of a typical Y/C circumvention device 82′ comparable to device 82 of FIG. 9A, comprising a regeneration circuit which replaces the incoming video's sync and or back porch levels with substantially normal levels. The regeneration circuit of FIG. 9B may replace a fixed level of pseudo sync and or AGC pulses by a regeneration or processing procedure, thereby reducing color effects of the copy protection signal.

A summary of one or more embodiments pertaining to the circumvention of (chroma) copy protection effects is stated as: Method or apparatus of reducing or defeating chroma copy protection effects in a component video signal, wherein the chrominance and luminance signals are separate, and wherein the luminance signal includes a copy protection signal, the method comprising modifying the luminance signal to reduce or remove the copy protection signal therein to restore the color saturation to a more normal balance. The copy protection signal may include lowering a portion of a back porch area in selected TV lines, wherein modifying the luminance signal includes modifying, raising, or offsetting the level of the lowered back porch area to restore the image from a de-saturated image when coupled to a recorder and TV set, to an image of a more normal color saturation. The modifying may further provide reducing the copy protection effect of overmodulation in a video recorder.

The copy protection signal may (further) include modulated AGC pulses, wherein the overmodulation occurs when the modulated AGC pulses are at minimum or zero attenuating effect in a recorder or AGC system, and wherein modifying or raising the lowered back porch area reduces or defeats the copy protection effect of overmodulation. One or more amplitude modulated AGC pulses may provide the copy protection signal, wherein the AGC pulses are within the range of −20 IRE to >100 IRE during a time interval. For example, wherein the amplitude modulated AGC pulses have a level of about −10 IRE to a level of at least 100 IRE.

These and additional features and advantages will be apparent from the description and drawings herein, and thus the scope of the invention is defined by the following claims and their equivalents.

What is claimed is:

1. Method of synthesizing chroma copy protection signals in a component video signal, wherein a luminance signal is decoupled from a chrominance signal comprising,
applying a copy protection signal to the luminance signal to cause an attenuation of the luminance signal in a recorder;
wherein the chrominance signal is not attenuated in the recorder; and
wherein the chrominance signal is effectively increased in level relative to the attenuated luminance signal, resulting in abnormal color saturation.

2. The method of claim 1 wherein the applied copy protection signal is automatic gain control (AGC) pulses, pseudo sync pulses, lowered back porch portions, and or reduced level of sync pulses.

3. The method of claim 2 further comprising:
decreasing the level of the pseudo sync and or AGC pulses essentially to zero;
lowering the level of at least a portion of a back porch or reducing the sync amplitude on selected video lines to cause an abnormally increased video level in the luminance signal;
wherein the greater luminance signal level causes a mismatch with the amplitude of the chrominance signal level which leads to color de-saturation in the output of an AGC system of a recorder.

4. The method of claim 1 further including:
modulating the copy protection signal applied to the luminance signal to provide a dynamic color oversaturation.

5. The method of claim 1 further including:
applying a color stripe burst or color burst modification to the chrominance signal to provide along with the luminance copy protection signal a static and or dynamic saturation or oversaturation of hue or tint errors in the recorder output signal.

6. The method of claim 1 including:
applying an enhancement signal to the luminance signal by lowering a back porch portion and or reducing the sync amplitude of selected sync pulses to cause an abnormally increased luminance video level relative to the chrominance video level which leads to de-saturation in the output signal from a recorder.

7. The method of claim 6 including modulating the copy protection signals with the enhancement signal to cause abnormally de-saturated to abnormally oversaturated color effects.

8. Method of synthesizing chroma copy protection signals in a component video signal, wherein a luminance signal is decoupled from a chrominance signal comprising,
applying a copy protection signal to the luminance signal to cause a change in the level of the luminance signal in a recorder; and
wherein the changed luminance signal has a different level relative to the chrominance signal, resulting in an erroneous color saturation.

9. The method of claim 8 wherein the copy protection signal includes AGC pulses and the erroneous color saturation is an abnormal chrominance signal level in the presence of a lowered luminance signal level caused by the AGC pulses.

10. The method of claim 9 wherein the abnormal chrominance signal level is an increase in level generally coincident with the occurrence of the lowered luminance signal level.

11. The method of claim 8 wherein the chrominance signal is not changed in level in the recorder.

12. The method of claim 11 wherein:
the luminance signal level is decreased or increased, resulting in a color oversaturation or de-saturation effect, respectively, of the chroma copy protection signals.

13. The method of claim 11 wherein the applied copy protection signal is automatic gain control (AGC) pulses, pseudo sync pulses, lowered back porch portions, and or reduced level of sync pulses.

14. The method of claim 13 further comprising:
decreasing the level of the pseudo sync and or AGC pulses essentially to zero;
lowering the level of at least a portion of a back porch or reducing the sync amplitude on selected video lines to cause an abnormally increased video level in the luminance signal;
wherein the greater luminance signal level causes a mismatch with the amplitude of the chrominance signal level which leads to color de-saturation in the output of an AGC system of a recorder.

15. The method of claim 11 further including:
modulating the copy protection signal applied to the luminance signal to provide a dynamic erroneous color saturation.

16. The method of claim 11 further including:
applying a color stripe burst or color burst modification to the chrominance signal to provide along with the luminance copy protection signal a static and or dynamic erroneous saturation of hue or tint errors in the recorder output signal.

17. The method of claim 11 including:
applying an enhancement signal to the luminance signal by lowering a back porch portion and or reducing the sync amplitude of selected sync pulses to cause an abnormally increased luminance video level relative to the chrominance video level which leads to color de-saturation in the output signal from a recorder.

18. The method of claim 17 wherein the step of applying the enhancement signal includes:
modulating the copy protection signals with the enhancement signal to cause abnormally de-saturated to abnormally oversaturated color effects.

19. Apparatus for synthesizing chroma copy protection signals in a component video signal, wherein a luminance signal is decoupled from a chrominance signal in an automatic gain control (AGC) circuit in a recorder, comprising:
a circuit for applying a copy protection signal to the luminance signal, to cause a difference in the luminance signal level relative to the chrominance signal level when the signals are passed through the recorder; and
wherein the difference in the luminance signal level relative to the chrominance signal level results in an erroneous color saturation effect.

20. The apparatus of claim 19 wherein the erroneous color saturation effect is an abnormal chrominance signal level in the presence of a lowered luminance signal level.

21. The apparatus of claim 19 further comprising:
a luminance processing circuit receiving the luminance signal for applying the copy protection signal thereto;
wherein the chrominance signal level is not changed in the recorder; and
wherein the difference in the signal levels causes the erroneous color saturation effect.

22. The apparatus of claim 21 further comprising:
a chrominance processing circuit wherein the chrominance signal level is not changed.

23. The apparatus of claim 21 wherein the luminance processing circuit includes a modulating circuit for modulating the copy protection signal applied to the luminance signal to provide a dynamic erroneous color saturation effect.

24. Method of modifying a chroma copy protection signal in a component video signal, wherein the chroma copy protection signal results from erroneous color saturation effects caused by a difference in the luminance signal and chrominance signal levels due to the application of selected copy protection signals to the luminance signal, the method comprising:
modifying the selected copy protected signals in the luminance signal to remove or reduce the erroneous color saturation effects.

25. The method of claim 24 wherein the selected copy protection signals include decreased levels of pseudo sync signals, AGC signals, back porch portions and or sync signals, wherein the step of modifying comprises:
increasing the level of the pseudo sync signals, AGC signals, back porch portions and or sync signals of the copy protection signals in the luminance signal so as to restore the color saturation in the chrominance signal to a more normal balance with the luminance signal.

26. Method of synthesizing chroma copy protection signals in a component video signal, wherein a luminance signal is decoupled from a chrominance signal comprising,
applying a copy protection signal to the luminance signal to cause an attenuation, or an increase, of the luminance signal in a recorder;
wherein the chrominance signal is not attenuated or increased in the recorder; and
wherein the chrominance signal is effectively increased or decreased in level relative to the attenuated or increased luminance signal, respectively, resulting in abnormal color saturation.

27. The method of claim 26 wherein:
the step of applying causes an attenuation of the luminance signal;
wherein the chrominance signal is not attenuated; and
wherein the chrominance signal is effectively increased in level relative to the attenuated luminance signal, resulting in color oversaturation.

28. The method of claim 26 wherein:
the step of applying causes an increase of the luminance signal;
wherein the chrominance signal is not increased; and
wherein the chrominance signal is effectively decreased in level relative to the increased luminance signal, resulting in color de-saturation.

29. Method of synthesizing chroma copy protection signals in a component video signal, wherein a luminance signal is decoupled from a chrominance signal, comprising:
applying a copy protection signal to the luminance signal to lower the level of the luminance signal relative to the chrominance signal in a recorder;
wherein the chrominance signal is greater in level in the presence of the lowered level of the luminance signal, resulting in color oversaturation.

30. The method of claim 29 wherein amplitude modulated AGC pulses provide the copy protection signal and wherein the AGC pulses are within the range of −20 IRE to >100 IRE during a time interval.

31. The method of claim 30 wherein the range of the AGC pulses causes a VCR system to range from overmodulation to undermodulation.

32. The method of claim 31 wherein the overmodulation to undermodulation of the VCR provides de-saturated colors to oversaturation of colors.

33. The method of claim 29 wherein amplitude modulated AGC pulses provide the copy protection signal and wherein the AGC pulses have a level of about −10 IRE to a level of at least 100 IRE.

34. Method of reducing or defeating chroma copy protection effects in a component video signal, wherein the chrominance and luminance signals are separate, and wherein the luminance signal includes a copy protection signal, the method comprising:
modifying the luminance signal to reduce or remove the copy protection signal therein to restore the color saturation to a more normal balance.

35. The method of claim 34 wherein the copy protection signal includes lowering a portion of a back porch area in selected TV lines, and wherein modifying the luminance signal includes modifying, raising, or offsetting the level of the lowered back porch area to restore the video signal from a de-saturated image when coupled to a recorder and TV set to an image of a more normal color saturation.

36. The method of claim 35 wherein the modifying further provides reducing the copy protection effect of overmodulation in a video recorder.

37. The method of claim 36 wherein the copy protection signal further includes modulated AGC pulses, and wherein the overmodulation occurs when the modulated AGC pulses are at minimum or zero attenuating effect on a recorder or AGC system, and wherein modifying or raising the lowered back porch area reduces or defeats the copy protection effect of overmodulation.
